(19) United States
(12) Patent Application Publication
(10) Pub. No.: US 2007/0246270 A1
(43) Pub. Date: Oct. 25, 2007

(54) Quick connect PTO shaft

(76) Inventors: Edward H. Priepke, Lancaster, PA (US); Kevin M. Smith, Narvon, PA (US); John H. Posselius, Ephrata, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/410,243

(22) Filed: Apr. 24, 2006

(51) Int. Cl. B60K 17/28

(52) U.S. Cl. 180/53.1

(57) ABSTRACT

A PTO shaft with a pilot formed on one end to carry or support the weight of a mobile work implement while the PTO assembly is being rotated for spline alignment.

### BACKGROUND OF THE INVENTION

The present invention relates generally to power-take-off (hereinafter “PTO”) shafts, and more specifically, to powered machinery having a PTO shaft that transfers rotational power to a mobile work implement.

Certain types of mobile work implements have mechanisms driven by a separate source of power rather than by, for example, the mere movement of the machine across the ground or by a machine mounted engine. An example of such a mobile work implement would be a forage harvester, spreader or rotary mower and the like connected to a tractor.

In the case of a mobile work implement like a forage harvester, spreader or rotary mower and the like, the engine of the towing tractor transfers rotational power to move both the tractor and the towed machine along the ground. The engine also delivers power to the mobile work implement, e.g., the spreading mechanism, through what is known as a PTO shaft. Usually, the PTO shaft is a rotating splined shaft which projects rearwardly from the rear of the tractor frame for a short distance; however, PTO shafts may also project from the front end of a tractor as well. Although the PTO shaft described herein projects rearwardly from the rear of a tractor frame, it is understood that the invention described relates to any PTO shaft, regardless of location on a powered machine.

The mobile work implement has a driveline comprising of a variable-length splined drive shaft which can be extended to connect to the tractor PTO shaft. When so connected (and when the mobile work implement tongue is coupled to the tractor draw bar or the three point hitch linkage, for example), the mobile work implement is towed along the ground while its working mechanism performs the intended task.

The PTO shaft of a tractor is typically an output shaft of the tractor gearbox, and the PTO shaft may be rearwardly directed so as to be readily connected to a mobile work implement. The connection in some cases is made by way of a variable-length splined drive shaft in a cylindrical housing and connected at one end to the PTO shaft via a universal joint or constant velocity joint and the like, and connected at the other end to the mobile work implement drive mechanism, again via a universal joint or constant velocity joint and the like. The PTO shaft of a tractor is typically driven at 540 rpm or 1,000 rpm, or in a two-speed arrangement, the PTO shaft may be driven at either 540 rpm or 1,000 rpm. It is well understood in this field of invention that the PTO shaft rpm varies with engine speed and the rotational speeds of 540 rpm and 1,000 rpm are typically the standard “rated” speeds for PTO driven implements.

Connecting the mobile work implement PTO assembly to the tractor PTO shaft can be cumbersome, especially with three point hitch-mounted mobile work implements, which cause limited accessibility to the connection area. In addition, the variable-length splined drive shaft of the mobile work implement must be rotated by hand, while lifting and holding the weight of the assembly in order to align the splines of the PTO shaft and the variable-length splined drive shaft of the mobile work implement for engagement. This can be a time consuming, dirty and difficult process for the operator and it increases the potential for operator injury.

It would be advantageous to provide a PTO shaft that overcomes the above-mentioned difficulties.

### SUMMARY OF THE INVENTION

Accordingly, it is an object of the present invention to provide an improved PTO shaft that reduces the amount of time required for connecting the tractor PTO shaft to the mobile work implement as well as the level of physical difficulty.

It is a further object of the present invention to provide an improved PTO shaft for transferring rotational power to a mobile work implement attached to the PTO shaft, the PTO shaft comprising a generally elongate rod-like member with a longitudinal axis, first and second opposing ends, and being generally circular in cross-section along the longitudinal axis, the cross-section defining a root diameter; the rod-like member including a plurality of generally identical longitudinal splines generally equally spaced around the peripheral surface of the rod-like member and defining a second peripheral surface with a second diameter greater than the root diameter, the splines extending in a longitudinal direction between a first plane spaced from the first end of the rod-like member and a second plane remote therefrom, the first and second planes being transverse to the horizontal axis of the rod-like member.

It is a another object of the present invention to provide an improved PTO shaft wherein there is a retention groove in the plurality of splines, the groove being circumferential to the rod-like member and having a diameter generally equal to the root diameter and the groove being located at a third plane between the first and second planes. The first end of the rod-like member being located at a greater distance from the third plane than the first plane along the longitudinal axis.

It is a further object of the present invention to provide an improved PTO shaft that adds little or no added manufacturing cost and reduces the likelihood of operator injury when connecting the PTO shaft to the mobile work implement PTO assembly.

These and other objects are achieved by providing a PTO shaft with a pilot formed on one end to carry or support the weight of the mobile work implement while the PTO assembly is being rotated for alignment. It is also an object to provide an improved PTO shaft that is economical in manufacture as well as facile in assemblage and use.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a diagrammatic side view of the tractor;

FIG. 2 is a perspective view of an embodiment of the invention in use, showing the connection of a mobile work implement to a tractor;

FIG. 3 is a cross-section through the front universal joint with the PTO shaft connected;

FIG. 4 is a side view of the front universal joint showing the weight of the mobile work implement resting on the PTO shaft; and

FIG. 5 is a perspective view of the improved PTO shaft with pilot formed on one end.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions.

The various aspects of the present invention are illustrated in this embodiment by reference to an agricultural tractor but it is to be understood that the invention is applicable to any apparatus having a PTO drive.

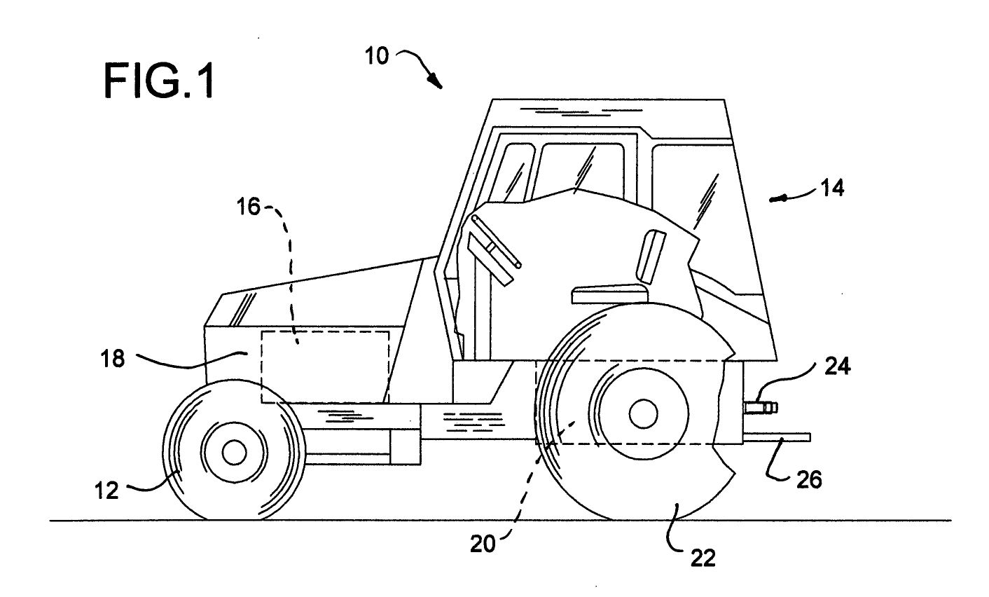

Referring to FIG. 1, the tractor 10 has a pair of front, steerable, ground-engaging wheels 12, and a cab 14 mounted on a basic frame or chassis (not shown) of the tractor 10, the engine 16 (schematically shown) is mounted within an engine compartment 18 at the front of the tractor 10. The engine 16 drives a gearbox 20 in the transmission (not shown) mounted towards the rear of the tractor 10 and having two output shafts, one of which drives the rear axle (not shown) on which the rear wheels 22 are mounted, and the other of which provides a power-take-off (PTO) shaft 24. A drawbar 26 is also provided at the rear of the tractor 10 which is connectable to a mobile work implement 34 such as a forage harvester, spreader or rotary mower and the like.

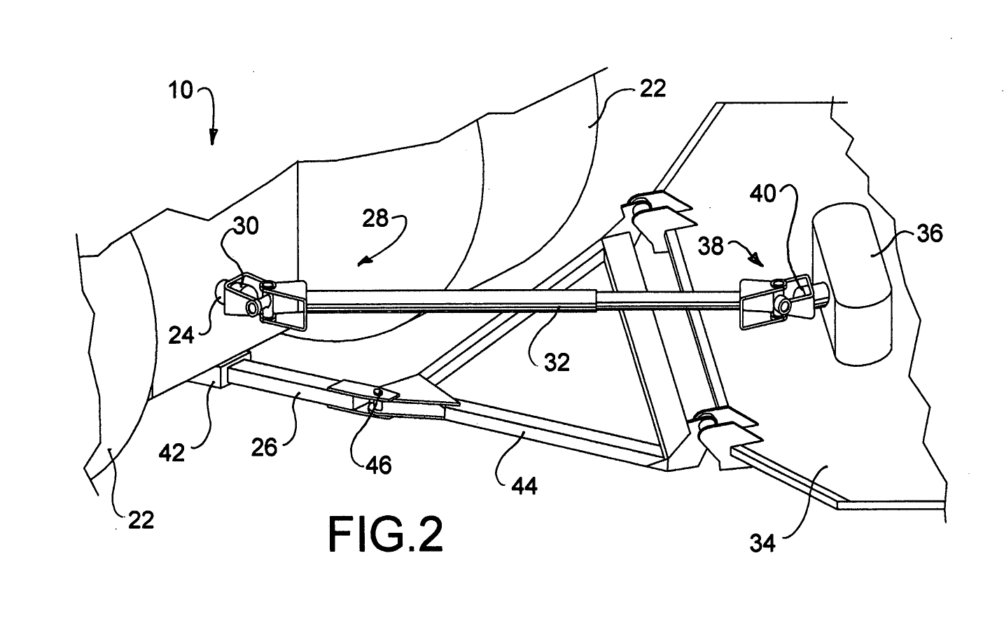

As can be seen in FIG. 2, PTO shaft 24 extends in a rearward direction from tractor 10 and is connected at one end to front universal joint 28 via a first push-pin or twist detent type locking mechanism 30 well-known in the agricultural business. The opposite end of front universal joint 28 is connected to the first end of variable-length splined drive shaft 32. The opposite end of variable-length splined drive shaft 32 is connected to drive mechanism 36 of mobile work implement 34 via a rear universal joint 38 by a locking mechanism 40. Mechanism 36 could be either mechanical, hydraulic, or a combination of the two, as known in the art. Drive shaft 32 is telescopic to allow the mobile work implement 34 to easily follow the movement of tractor 10 as it turns, and to allow attachment of the drive shaft to the tractor PTO. Thus, PTO shaft 24 transfers rotational power through the above-mentioned connections to drive mechanism 36 of mobile work implement 34.

Drawbar 26 extends in a rearward direction from tractor 10 and is connected at one end to receiver hitch 42 while the opposite end of the drawbar is connected to hitch 44 via a hitch pin 46. Hitch 44 is connected to mobile work implement 34 in a manner well-known in the art.

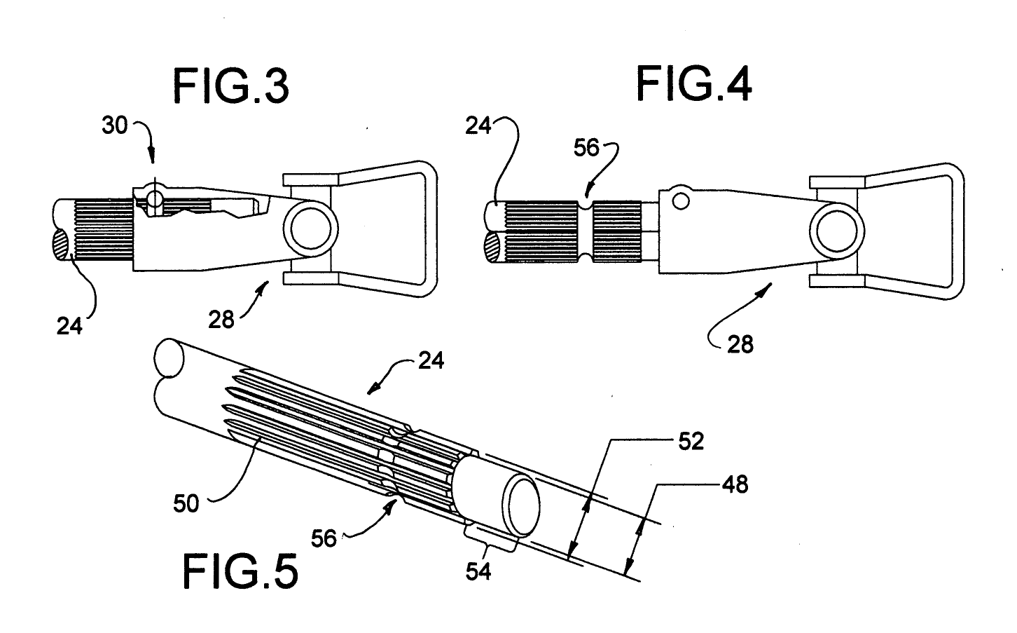

As can be seen in FIGS. 3, 4 and 5, the improved PTO shaft 24 in the preferred embodiment is generally of ASAE S203.12 dimensions, comprising an elongate rod-like member with a circular cross-section that defines a root diameter 48. PTO shaft 24 includes a plurality of identical, longitudinal splines 50 equally-spaced around the surface of PTO shaft 24 that form a second diameter 52 greater than the root diameter 48. Shaft 24 is modified with the formation of a pilot 54 on one end that carries/supports the weight of the drive shaft 32 while the variable-length splined drive shaft 32 is being rotated for alignment and final engagement with drive shaft 24, significantly reducing the difficulty of making the connection. Pilot 54 has a diameter that is essentially equal to the root diameter 48.

PTO shaft 24 further includes a retention groove 56 in the plurality of splines that is circumferential to the PTO shaft 24 and has a diameter generally equal to the root diameter 48. Retention groove 56 allows shaft 24 to securely connect to the push-pin or twist detent locking mechanism 30 of front universal joint 28. Pilot 54 should be of a sufficient length to support the weight of front universal joint 28 on PTO shaft 24 without interfering with the alignment of splines. In the preferred embodiment, the length of pilot 54 is approximately 20 mm, but the length of pilot 54 should be in the range of 15 to 25 mm.

It can thus be seen that the invention provides a PTO shaft that allows for the easier connection of a mobile work implement to a tractor. By forming a pilot on one end of the PTO shaft, the weight of the mobile work implement variable-length splined drive shaft can rest on the pilot while the operator easily rotates the shafts for spline engagement.

It will be understood that changes in the details, materials, steps and arrangements of parts which have been described and illustrated to explain the nature of the invention will occur to and may be made by those skilled in the art upon a reading of this disclosure within the principles and scope of the invention. For example, the primary tractor/implement connection is shown as an ordinary hitch; however, a three-point hitch would work just as well. The foregoing description illustrates the preferred embodiment of the invention; however, concepts, as based upon the description, may be employed in other embodiments without departing from the scope of the inventions. Accordingly, the following claims are intended to protect the invention broadly as well as in the specific form shown.

Having thus described the invention, what is claimed is:

1. In a tractor having a forward end and an opposing rear end generally defined by the normal direction of travel of the tractor, the tractor further having a PTO shaft for transferring rotational power to an implement attached to the PTO shaft, the improvement comprising:
a PTO shaft extending generally horizontally away from the rear of the tractor, the PTO shaft being a generally elongate rod-like member with a longitudinal axis, first and second opposing ends, and being generally circular in cross-section along the longitudinal axis, the cross-section defining a root diameter;
the rod-like member including a plurality of generally identical longitudinal splines generally equally spaced around the peripheral surface of the rod-like member and defining a second peripheral surface with a second diameter greater than the root diameter, the splines extending in a longitudinal direction between a first plane spaced from the first end of the rod-like member and a second plane remote therefrom, the first and second planes being transverse to the horizontal axis of the rod-like member;
a retention groove in the plurality of splines, the groove being circumferential to the rod-like member and having a diameter generally equal to the root diameter, the groove located at a third plane between the first and second planes; and
the first end of the rod-like member being located at a greater distance from the third plane than the first plane along the longitudinal axis.

2. The improvement of claim 1, wherein:
the distance between the first plane and the first end of the rod-like member is in the range of approximately 15 to 25 mm.

3. The improvement of claim 1, wherein:
the distance between the third plane and the first end of the rod-like member is approximately 38 mm and the root diameter is approximately 30 mm.

4. The improvement of claim 3, wherein:
the distance between the first plane and the first end of the rod-like member is approximately 20 mm.

5. The improvement of claim 1, wherein:
the distance between the third plane and the first end of the rod-like member is approximately 25 mm and the root diameter is approximately 32 mm.

6. The improvement of claim 5, wherein:
the distance between the first plane and the first end of the rod-like member is approximately 20 mm.

7. The improvement of claim 1, wherein;
the distance between the third plane and the first end of the rod-like member is approximately 38 mm and the root diameter is approximately 40 mm.

8. The improvement of claim 7, wherein:
the distance between the first plane and the first end of the rod-like member is approximately 20 mm.

9. A PTO shaft comprising:
a generally elongate rod-like member with a longitudinal axis, first and second opposing ends, and being generally circular in cross-section along the longitudinal axis, the cross-section defining a root diameter;
the rod-like member including a plurality of generally identical longitudinal splines generally equally spaced around the peripheral surface of the rod-like member and defining a second peripheral surface with a second diameter greater than the root diameter, the splines extending in a longitudinal direction between a first plane spaced from the first end of the rod-like member and a second plane remote therefrom, the first and second planes being transverse to the horizontal axis of the rod-like member;
a retention groove in the plurality of splines, the groove being circumferential to the rod-like member and having a diameter generally equal to the root diameter, the groove located at a third plane between the first and second planes; and
the first end of the rod-like member being located at a greater distance from the third plane than the first plane along the longitudinal axis.

10. The improvement of claim 9, wherein:
the distance between the first plane and the first end of the rod-like member is in the range of approximately 15 to 25 mm.

11. The improvement of claim 9, wherein:
the distance between the third plane and the first end of the rod-like member is approximately 38 mm and the root diameter is approximately 30 mm.

12. The improvement of claim 11, wherein:
the distance between the first plane and the first end of the rod-like member is approximately 20 mm.

13. The improvement of claim 9, wherein:
the distance between the third plane and the first end of the rod-like member is approximately 25 mm and the root diameter is approximately 32 mm.

14. The improvement of claim 13, wherein:
the distance between the first plane and the first end of the rod-like member is approximately 20 mm.

15. The improvement of claim 9, wherein;
the distance between the third plane and the first end of the rod-like member is approximately 38 mm and the root diameter is approximately 40 mm.

16. The improvement of claim 15, wherein:
the distance between the first plane and the first end of the rod-like member is approximately 20 mm.

17. An agricultural tractor PTO drive system comprising:
a tractor with a primary power source;
a PTO shaft extending outwardly from the tractor, the PTO shaft comprising:
a rotational speed control mechanism interconnecting the primary power source and the PTO shaft to selectively control the rotational speed of the PTO shaft;
a generally elongate rod-like member with a longitudinal axis, first and second opposing ends, and being generally circular in cross-section along the longitudinal axis, the cross-section defining a root diameter;
the rod-like member including a plurality of generally identical longitudinal splines generally equally spaced around the peripheral surface of the rod-like member and defining a second peripheral surface with a second diameter greater than the root diameter, the splines extending in a longitudinal direction between a first plane spaced from the first end of the rod-like member and a second plane remote therefrom, the first and second planes being transverse to the horizontal axis of the rod-like member;
a retention groove in the plurality of splines, the groove being circumferential to the rod-like member and having a diameter generally equal to the root diameter, the groove located at a third plane between the first and second planes;
the first end of the rod-like member being located at a greater distance from the third plane than the first plane along the longitudinal axis.

18. The improvement of claim 17, wherein:
the distance between the first plane and the first end of the rod-like member is in the range of approximately 15 to 25 mm.

19. The improvement of claim 17, wherein:
the distance between the third plane and the first end of the rod-like member is approximately 38 mm and the root diameter is approximately 30 mm.

20. The improvement of claim 19, wherein:
the distance between the first plane and the first end of the rod-like member is approximately 20 mm.

21. The improvement of claim 17, wherein:
the distance between the third plane and the first end of the rod-like member is approximately 25 mm and the root diameter is approximately 32 mm.

22. The improvement of claim 21, wherein:
the distance between the first plane and the first end of the rod-like member is approximately 20 mm.

23. The improvement of claim 17, wherein;
the distance between the third plane and the first end of the rod-like member is approximately 38 mm and the root diameter is approximately 40 mm.

24. The improvement of claim 23, wherein:
the distance between the first plane and the first end of the rod-like member is approximately 20 mm.
